(19) United States
(12) Patent Application Publication
(10) Pub. No.: US 2025/0027645 A1
(43) Pub. Date: Jan. 23, 2025

(54) Lightweight Pressure Reduction Hydrogen Supply Device Suitable for Hydrogen Energy Handheld Torch

(71) Applicants: BEIJING AEROSPACE PROPULSION INSTITUTE, Beijing (CN); BEIJING AEROSPACE PETROCHEMICAL TECHNOLOGY & EQUIPMENT ENGINEERING CORPORATION LIMITED, Beijing (CN)

(72) Inventors: Xiaofeng Li, Beijing (CN); Yingren Ding, Beijing (CN); Xiaodong Zheng, Beijing (CN); Xincheng Wang, Beijing (CN); Yang Gao, Beijing (CN)

(21) Appl. No.: 18/716,657

(22) PCT Filed: Apr. 11, 2022
(86) PCT No.: PCT/CN2022/086009

§ 371 Date: Jun. 5, 2024

(30) Foreign Application Priority Data
Dec. 6, 2021 (CN) 202111481514.X

(51) Int. Cl. F23D 14/38; F23D 14/46; F23D 14/72

(52) U.S. Cl. CPC F23D 14/38; F23D 14/465; F23D 14/72

(57) ABSTRACT

A lightweight depressurization hydrogen supply device suitable for a hydrogen energy handheld torch is provided. The device is configured to connect a gas cylinder to a combustor in the torch and includes a cylinder opening valve, a pressure reducing valve, a switch assembly, a switch actuating component, and a gas cylinder cap. The pressure reducing valve is configured to perform depressurization of high pressure hydrogen, and is provided with three butting ports. A lower butting port is connected to the gas cylinder cap, an upper butting port is connected to the combustor, a side butting port is provided with the switch assembly, and the switch actuating component and the cylinder opening valve are installed in the gas cylinder cap. The switch assembly is configured to control the switch actuating component to open or close the cylinder opening valve. The cylinder opening valve is connected to a cylinder opening of the gas cylinder and configured to open or close the gas cylinder.

### CROSS-REFERENCE TO RELATED APPLICATION

This application is a National Stage Application under 35 USC § 371 of International Application PCT/CN2022/086009, filed Apr. 11, 2022, which claims the benefit of and priority to Chinese Patent Application No. 202111481514.X, entitled “LIGHTWEIGHT PRESSURE REDUCTION HYDROGEN SUPPLY DEVICE SUITABLE FOR HYDROGEN ENERGY HANDHELD TORCH”, filed with the China National Intellectual Property Administration on Dec. 6, 2021, the entire content of which is incorporated herein by reference.

### FIELD

The present disclosure relates to the field of valves, and more particularly to a lightweight depressurization hydrogen supply device suitable for a hydrogen energy handheld torch.

### BACKGROUND

In various large-scale events, a handheld torch is often used to transfer fire. Since a process of transferring the torch is performed outdoors, an external environment has a great influence on torch combustion. At present, torch fuels used at home and abroad are mainly propane. Propane liquid is gasified in a gas cylinder, and propane gas is provided to a combustor. In a process of using propane, there are some problems, such as low temperature resistance, poor wind resistance and rain resistance, which easily lead to the torch being extinguished.

With a phased goal of peak carbon dioxide emissions and carbon neutrality put forward by China, hydrogen, as a cleanest energy source nowadays, is one of most promising clean energy sources in the 21^{st} century with merely water as its combustion product. A combustion speed of the hydrogen is fast, and once the hydrogen is ignited, it is difficult to extinguish. The hydrogen has good wind resistance and rain resistance. Since a critical temperature of hydrogen is −198° C., the hydrogen merely exists in a gaseous form at room temperature. After being released from the gas cylinder and reaching the combustor, the hydrogen is directly combusted, which is more suitable for low temperature environment. Therefore, hydrogen may be used as a torch fuel. On the one hand, it may better solve problems existing in a traditional torch, on the other hand, it may convey the spiritual connotation of science and technology and green to the audience.

Hydrogen may merely be stored in the gaseous form at room temperature. In order to ensure a certain combustion time, an amount of hydrogen may merely be met by increasing a storage pressure in a limited gas cylinder volume, and the pressure may reach 70 MPa G, which is much higher than that of the traditional torch. Due to an extremely small molecular weight of hydrogen, higher requirements are put forward for reliable sealing, and a dimension and weight of each component are strictly required for the handheld torch, so a lightweight depressurization hydrogen supply device suitable for a hydrogen energy handheld torch is needed. The lightweight depressurization hydrogen supply device is configured to connect the gas cylinder to the combustor in a torch combustion system in series, and is configured to open the gas cylinder, perform depressurization and provide hydrogen with a fixed flow after releasing the high pressure hydrogen, and provide a pressure needed by the combustor, thus solving problems of depressurization at a large depressurization ratio, high precision pressure stabilization, high reliable sealing, and a low opening and closing torque, and having advantages of small size and low weight.

### SUMMARY

A lightweight depressurization hydrogen supply device suitable for a hydrogen energy handheld torch is provided. The device is configured to connect a gas cylinder to a combustor in the torch and includes a cylinder opening valve, a pressure reducing valve, a switch assembly, a switch actuating component, and a gas cylinder cap. The pressure reducing valve is configured to perform depressurization of high-pressure hydrogen, and is provided with three butting ports. A lower butting port is connected to the gas cylinder cap, an upper butting port is connected to the combustor, a side butting port is provided with the switch assembly, and the switch actuating component and the cylinder opening valve are installed in the gas cylinder cap. The switch assembly is configured to control the switch actuating component to open or close the cylinder opening valve. The cylinder opening valve is connected to a cylinder opening of the gas cylinder and configured to open or close the gas cylinder.

### BRIEF DESCRIPTION OF THE DRAWINGS

FIG. 1 is a schematic diagram of a lightweight depressurization hydrogen supply device according to the present disclosure.

FIG. 2 is a schematic diagram of a force balance of a switch assembly according to the present disclosure.

FIG. 3-1 is a schematic diagram of a position relationship between a switch assembly at a fully opening position and an ejector pin according to the present disclosure.

FIG. 3-2 is a schematic diagram of a position relationship between a switch assembly at a fully closing position and an ejector pin according to the present disclosure.

FIG. 4 is a schematic diagram of hydrogen flowing through an ejector pin according to the present disclosure.

FIG. 5 is a schematic diagram of a cylinder opening valve according to the present disclosure.

FIG. 6 is a schematic diagram of a sealing principle of a valve core assembly under different working conditions.

FIG. 7 is a schematic diagram of flow of hydrogen when a one-way cylinder opening valve is opened.

FIG. 8 is a schematic diagram of a single spring high-pressure pressure reducer according to the present disclosure.

FIG. 9 is a schematic cross-sectional view of a piston assembly.

### DETAILED DESCRIPTION

The present disclosure is described in detail below in combination with examples.

A lightweight depressurization hydrogen supply device suitable for a hydrogen energy handheld torch provided in the present disclosure is described in detail below in combination with the accompanying drawings and specific implementations.

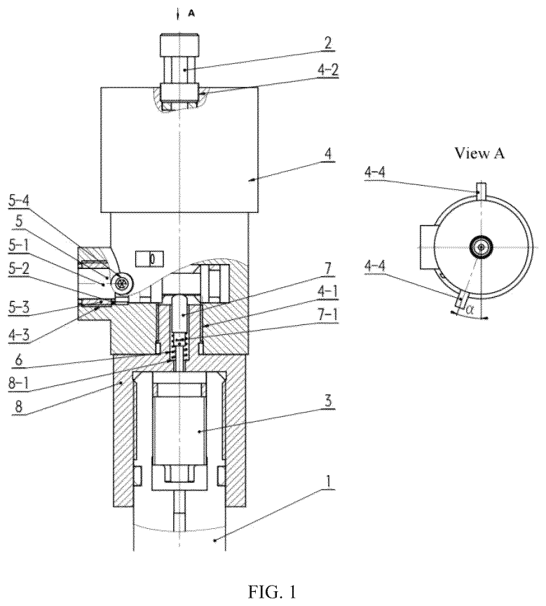

As shown in FIG. 1, a lightweight depressurization hydrogen supply device is configured to connect a gas cylinder 1 to a combustor 2 in a torch combustion system into a whole. The lightweight depressurization hydrogen supply device includes a cylinder opening valve 3, a pressure reducing valve 4, a switch assembly 5, a small spring 6, an ejector pin 7, and a gas cylinder cap 8.

As shown in FIG. 1, the cylinder opening valve 3 is installed at a cylinder opening of the gas cylinder 1, and is configured to open or close the gas cylinder 1. The cylinder opening valve 3 is connected to the gas cylinder 1 via threads and is provided with a sealing ring.

As shown in FIG. 1, the pressure reducing valve 4 is provided with three butting ports. A lower butting port 4-1 is connected to the gas cylinder cap 8 via threads and is provided with a sealing ring. An upper butting port 4-2 is connected to the combustor 2 via threads and is provided with a gasket. A side butting port 4-3 is provided with the switch assembly 5. The pressure reducing valve 4 is also provided with two lugs 4-4, and a lug angle α may be changed according to an actual application, and the lightweight depressurization hydrogen supply device is fixed by fastening screws, and the pressure reducing valve integrates the switch assembly and a fixing mechanism of the device into a whole.

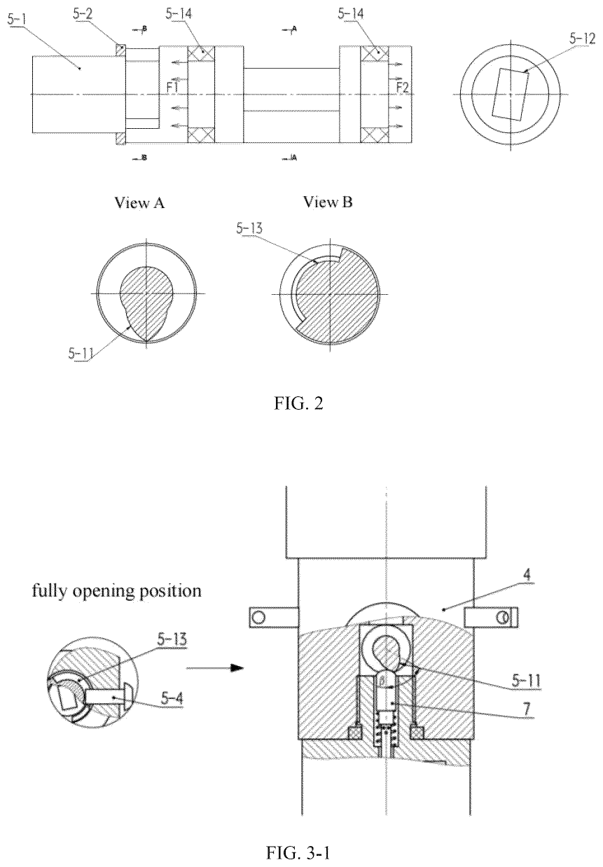

The switch assembly includes a cam 5-1, a gasket 5-2, a compression nut 5-3 and a screw 5-4. The compression nut 5-3 is connected to the side butting port 4-3 of the pressure reducing valve via threads, and compresses the gasket 5-2 and the cam 5-1. As shown in FIG. 2, the cam is installed at the side butting port of the pressure reducing valve and is divided into four portions in sequence along an axis of the butting port. An outermost portion 5-1 is connected to the side butting port via the compression nut 5-3, and the gasket 5-2 and the outermost portion are compressed by the compression nut. A second portion adjacent to the outermost portion is provided with a groove 5-13. The screw 5-4 is installed in the groove to form an opening and closing limit structure of the cam to prevent the valve from closing automatically. The third portion is a cam convex surface 5-11, a position of the cam convex surface 5-11 corresponds to that of a switch actuating part. The cam convex surface is configured to change an opening and closing manner of the cylinder opening valve from linear motion to rotation. The second portion and a fourth portion are provided with sealing rings 5-14, and axial forces exerted on the cam are counteracted by a double sealing ring structure. An end face of the outermost portion is provided with a key slot 5-12, and a driving force for the rotation of the cam is provided via the key slot. When the cam is rotated counterclockwise, the cam convex surface 5-11 presses down the ejector pin 7, and the cylinder opening valve 3 is opened. When the cam 5-1 is rotated clockwise, the cam convex surface 5-11 is separated from the ejector pin 7, and the cylinder opening valve 3 is closed.

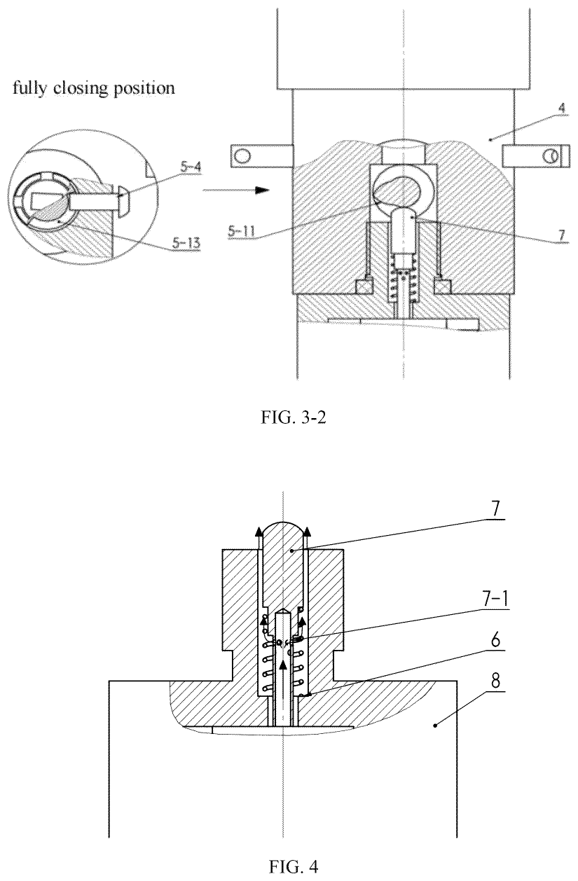

As shown in FIG. 3-1, the screw 5-4 is installed in a threaded hole of the side butting port 4-3 of the pressure reducing valve, and the screw 5-4 is located in the groove 5-13 of the cam to form an opening and closing mechanical limit mechanism of the device. The cam 5-1 may merely rotate within the scope of the groove 5-13.

As shown in FIG. 3-1, the screw 5-4 is in close contact with one end of the groove 5-13 of the cam, and the switch assembly is located at an opening limit position at this time. The cam is rotated counterclockwise, and the cylinder opening valve 3 is opened. After a tip of the cam convex surface 5-11 rotates to reach a lowest point, the tip of the cam convex surface continues to move until the tip of the cam convex surface forms a slight included angle β with a vertical direction. B is in a range of 3° to 18°, preferably 5° to 10°. The screw 5-4 in close contact with the other end of the groove 5-13 of the cam, and the cam cannot continue to rotate counterclockwise. The switch assembly is located at a closing limit position at this time, as shown in FIG. 3-2. An opening force of the cylinder opening valve 3 is a force applied by the cam to the ejector pin 7, and at the same time, the ejector pin 7 gives the cam a reaction force. The reaction force is applied to the cam convex surface 5-11. When the switch assembly is located at a fully opening position, the reaction force will cause the cam to rotate counterclockwise, and the opening limit mechanism may limit the rotation of the cam and prevent the valve from automatically closing due to the reaction force.

As shown in FIG. 2, the cam 5-1 is provided with the double sealing rings 5-14. The double sealing rings of the cam have the same size. By using a principle of force balance, axial forces F1 and F2 exerted on the cam in two directions are counteracted, and the gasket 5-2 is made of a low friction material to reduce a friction force during the rotation of the cam. The axial force exerted on the cam are counteracted, and the gasket 5-2 has a low friction coefficient. Thus, an opening and closing torque of the cylinder opening valve 3 is effectively reduced, and the opening and closing torque is lower than 4N·m.

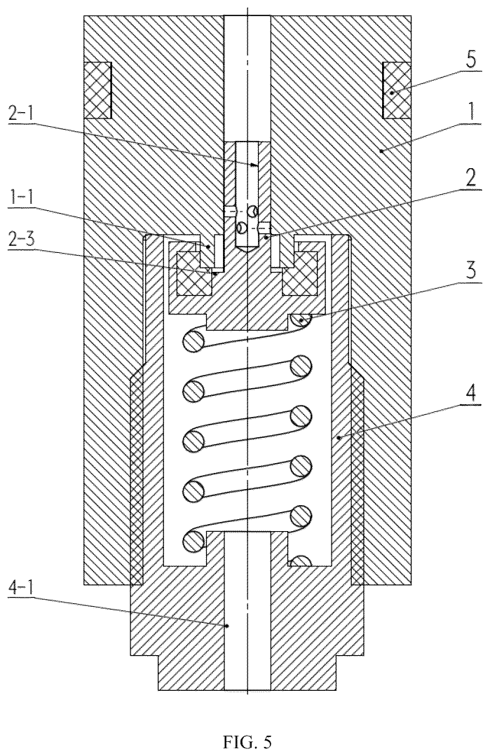

As shown in FIG. 4, the small spring 6 is arranged on an annular step 8-1 of the gas cylinder cap, and the ejector pin 7 is arranged in the small spring. After being released from the cylinder opening valve 3, the high-pressure hydrogen enters the pressure reducing valve 4 via an air guide hole 7-1 of the ejector pin. Two ends of the gas cylinder cap 8 are provided with threads. The threads are respectively connected to the gas cylinder 1 and the pressure reducing valve 4.

As shown in FIG. 4, the small spring 6 is arranged on the annular step of the gas cylinder cap 8, and the ejector pin 7 is arranged in the small spring 6, and the ejector pin is provided with the air guide hole. After being released by the cylinder opening valve 3, the high-pressure hydrogen enters the pressure reducing valve 4 via the air guide hole 7-1 of the ejector pin.

As shown in FIG. 1, the gas cylinder cap 8 is respectively connected to the gas cylinder 1 and the pressure reducing valve 4 via the threads, and the gas cylinder 1 and the pressure reducing valve 4 are connected into a whole, and the sealing ring is provided to ensure sealing. Since the small spring 6 and the ejector pin 7 are installed in the gas cylinder cap 8 and the cylinder opening valve 3 is installed in the gas cylinder 1, the gas cylinder cap 8 organically connects the cylinder opening valve 3, the pressure reducing valve 4, the switch assembly 5, the small spring 6 and the ejector pin 7 into a whole. The lightweight depressurization hydrogen supply device has a compact two-end structure in appearance, which provides a reasonable valve solution for the hydrogen energy handheld torch.

The pressure reducing valve 4 is connected to the gas cylinder cap 8 at the bottom and to the combustor 2 at the top, and the switch assembly 5 is arranged at a side surface, so that the switch assembly 5 and the fixing mechanism 4-4 of the lightweight depressurization hydrogen supply device are integrated into a whole. The device of the present disclosure has a compact two-end structure, an upper end is the pressure reducing valve 4, a lower end is the gas cylinder cap 8, and the rest of parts are built in, thus providing a reasonable valve solution for the hydrogen energy handheld torch.

In the lightweight depressurization hydrogen supply device, materials are reasonably selected for all components. The cylinder opening valve 3 and the switch assembly 5 are made of high-strength steel, the gasket 5-2 is made of a low friction material, the pressure reducing valve 4 and the gas cylinder cap 8 are made of low-density metal materials, and the sealing ring is made of materials with a wide applicable temperature range, which not only meets requirements of strength, sealing and temperature, but also takes into account weight and size. The device is suitable for a pressure of 1 MPa G to 70 MPa G, an operating temperature of −40° C. to 60° C., a weight of less than 230 g, an axial dimension of less than 180 mm, and a radial dimension of less than 60 mm. As mentioned above, the lightweight depressurization hydrogen supply device suitable for a hydrogen energy handheld torch is configured to connect the gas cylinder to the combustor in a hydrogen energy handheld torch combustion system, which solves problems of depressurization at a large depressurization ratio, high reliable sealing, the low opening and closing torque, and has advantages of wide temperature range, miniaturization and lightweight.

In the present disclosure, the cylinder opening valve and the pressure reducing valve may both adopt products in the prior art that may realize the above functions. The present disclosure gives a preferred and unique implementation, which is introduced below, respectively.

### 1. Cylinder Opening Valve

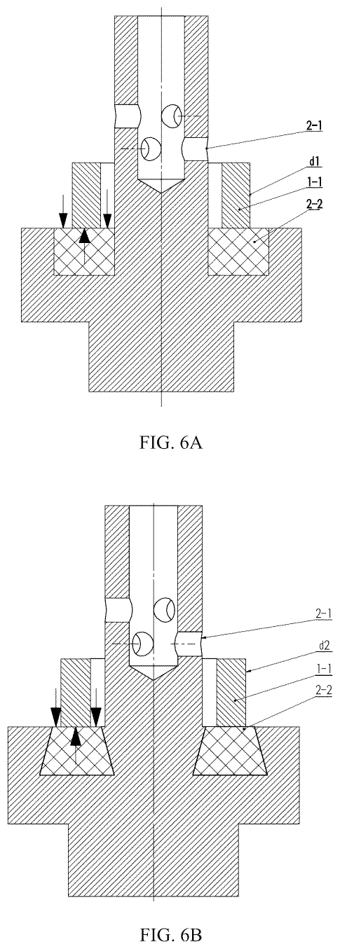

As shown in FIG. 5, the cylinder opening valve in the present disclosure is a one-way cylinder opening valve, which is composed of a valve body 1, a valve core assembly 2, a spring 3, a spring chamber 4 and a sealing ring 5. The valve core assembly 2 and the spring 3 are arranged in the spring chamber 4. The spring chamber 4 is connected to the valve body 1 via internal threads, and the valve body 1 is connected to the gas cylinder via external threads. The sealing ring 5 is arranged on an outer side of the valve body 1, so as to ensure the sealing between the valve and the gas cylinder. The valve core assembly 2 and the spring 3 are arranged in the spring chamber 4. The spring chamber 4 is connected to the valve body 1 via the internal threads, and the valve body 1 may be connected to the gas cylinder via the external threads. The sealing ring 5 is arranged on the outer side of the valve body 1 to ensure the sealing between the valve and the gas cylinder, and a function of hydrogen filling is achieved. According to different operating pressures, the one-way cylinder opening valve is configured with valve core assemblies having different structures, including in a form of an inlaid or injection-molded non-metallic material, and in a form of an extruded sealing ring. When the valve core assembly is in the form of the inlaid or injection-molded non-metallic material, a direction of a force applied to the valve core assembly is perpendicular to a deformation direction of the material, which is suitable for hydrogen working conditions below 20 MPa G. When the valve core assembly is in the form of the extruded sealing ring, a direction of a force applied to the valve core assembly is at a wide angle to the deformation direction of the material, which is suitable for hydrogen working conditions of 70 MPa G.

As shown in FIG. 5, the internal threads of the valve body 1 are configured to connect the valve body 1 to the spring chamber 4. The external threads are configured to connect the one-way cylinder opening valve to the gas cylinder. The sealing ring 5 is arranged on the outer side of the valve body 1, so as to ensure the sealing between the valve and the gas cylinder. An upper end of an inner chamber of the valve body is provided with an annular sealing lip 1-1, which is a sealing surface of the valve body 1. The spring 3 is arranged in the spring chamber 4, and a spring force is configured to provide a sealing force for the valve core assembly 2. In addition, an upward medium force is applied to the valve core assembly 2 in an under-pressure state, so as to ensure the sealing of high-pressure hydrogen. The valve core assembly 2 has various forms, such as the inlaid or injection-molded non-metallic material, and the extruded sealing ring, which may be selected according to the operating pressures.

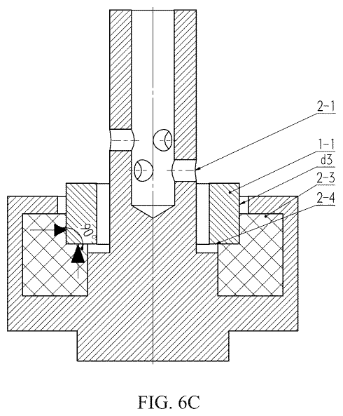

According to different operating pressures, the one-way cylinder opening valve is configured with the valve core assemblies having different structures, which has characteristics of reliable sealing, miniaturization and lightweight, and also has the function of hydrogen filling to meet needs of the gas cylinder in the hydrogen energy handheld torch. FIGS. 6A-6C show the valve core assemblies 2 having different forms, and the valve core assemblies 2 are provided with air guide holes 2-1. FIG. 6A shows the valve core assembly 2 in the form of the inlaid non-metallic material. The non-metallic material may be a polytetrafluoroethylene, a nylon, etc., which is suitable for an operating pressure of 10 MPa. FIG. 6B shows the valve core assembly 2 in the form of the injection-molded non-metallic material, and the non-metallic material may be a polyetheretherketone resin, a polyimide, etc., which is suitable for an operating pressure of 20 MPa. FIG. 6C shows the valve core assembly 2 in the form of the extruded sealing ring, which is suitable for an operating pressure of 70 MPa. A sealing principle of the valve core assemblies in FIGS. 6A and 6B is that the valve body sealing lip 1-1 vertically compresses the non-metallic material 2-2 of the valve core assembly to achieve sealing after reaching a sealing specific pressure of the material. The two valve core assemblies are provided with small sealing structures, and medium pressures applied to the valve core assemblies are small, so that a valve opening force is small. A diameter d1 of the valve body sealing lip matched with the valve core assembly in the form of the inlaid non-metallic material ranges from 2 to 10 mm, preferably from 2.5 to 8 mm. A diameter d2 of the valve body sealing lip matched with the valve core assembly in the form of the injection-molded non-metallic material ranges from 2 to 8 mm, preferably from 2.5 to 7 mm. A diameter d3 of the valve body sealing lip matched with the valve core assembly in the form of the extruded sealing ring ranges from 2 to 5 mm, preferably from 2.5 to 4 mm.

FIG. 6C shows the valve core assembly 2 in the form of the extruded sealing ring, which is a soft and hard tight fitting sealing structure. A sealing principle of the valve core assembly in FIG. 6C is that the sealing ring 2-3 wraps an outer edge of the valve body sealing lip 1-1 with an enveloping angle of 90° to ensure sealing in both radial and axial directions, and the valve body sealing lip and the valve core assembly are provided with metal stops 2-4 to prevent the valve body sealing lip 1-1 from crushing an axial position of the sealing ring 2-3 under a high-pressure working condition. Such valve core assembly structure may still adopt a small sealing structure dimension d3, and d3 ranges from 2 to 5 mm, preferably from 2.5 to 4 mm. Although a medium pressure is high, a medium force applied to the valve core assembly is small, so an opening and closing force of the cylinder opening valve is small, which is suitable for operating needs of high pressure and low opening force.

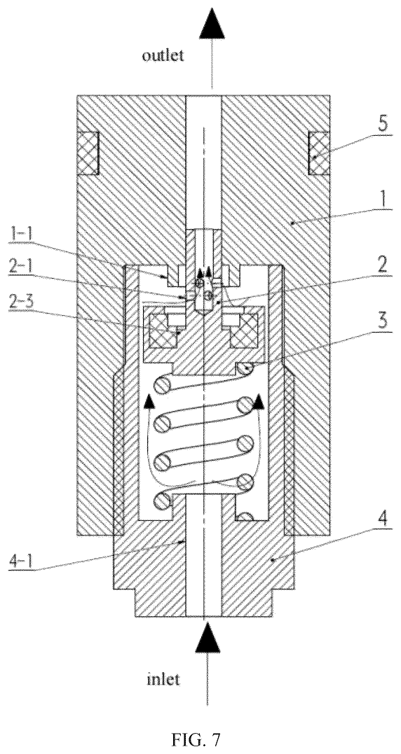

As shown in FIG. 7, when a downward opening force is applied to the one-way cylinder opening valve, the valve core assembly 2 overcomes the medium force and the spring force to generate a downward displacement, and hydrogen flows through spring chamber 4 and the valve core assembly sequentially to realize a hydrogen releasing function. When the valve is in an open state, the hydrogen flows reversely to realize a hydrogen charging function. As shown in FIG. 1, when the opening force is withdrawn and the upward medium force and the spring force are applied to the valve core assembly 2, the valve core assembly 2 automatically returns to its original position and the valve is closed.

As shown in FIG. 5, the spring 3 is arranged in the spring chamber 4 to provide the sealing force for the valve core assembly in the form of the inlaid or injection-molded non-metallic material. As shown in FIG. 1, the spring chamber 4 is arranged and is connected to the valve body 1 via the threads, so that the valve core assembly 2 and the spring 3 are arranged in the spring chamber 4, and a lower end of the spring chamber 4 is provided with a through hole 4-1, which is an inlet of the cylinder opening valve.

### 2. Pressure Reducing Valve

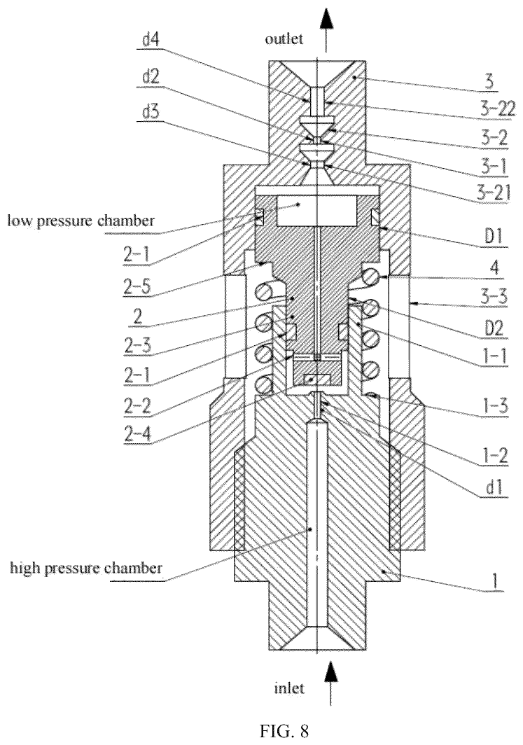

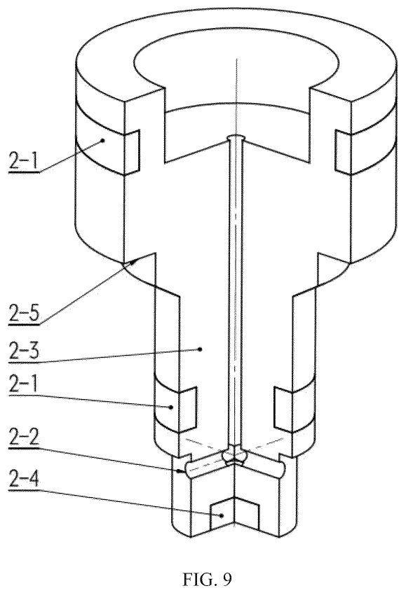

As shown in FIGS. 8 and 9, a single spring high-pressure pressure reducer in the present disclosure includes a valve body 1, a piston assembly 2, a valve cover 3 and a spring 4. The spring 4 is installed on a step at an upper end of the valve body 1, and a small end of the piston assembly 2 is installed in a cylinder 1-1 at the upper end of the valve body. The valve body 1 and the valve cover 3 are connected via threads, so that a large end of the piston assembly 2 is located in the valve cover 3, and the piston assembly 2 is provided with double sealing rings to ensure sealing.

The upper end of the valve body is provided with the cylinder 1-1, and a throat 1-2 is arranged at a bottom of the cylinder 1-1, which is a first depressurization structure of the valve. A high-pressure chamber is arranged below the first depressurization structure. A pressure of the high-pressure chamber is the same as an inlet pressure of the valve.

The outside of the piston assembly 2 is provided with a double sealing ring 2-1, and the inside of the piston assembly 2 is provided with an air guide hole 2-2. The piston assembly 2 is composed of a piston 2-3 and a non-metallic material 2-4 nested in a small end surface. The piston consists of four stepped cylindrical surfaces whose diameters increase sequentially. An end surface of a cylindrical surface at a smallest end is nested with a non-metallic material for protecting the first depressurization structure 1-2 of the valve body to avoid mechanical damage. Guide holes are provided around side surfaces to a center, converge to the center and communicate with the guide holes on a central axis to an inner hole at the large end. Sealing rings are arranged on an outer side of a cylindrical surface at a largest end and an outer side of a cylindrical surface with a second small diameter. That is, the double sealing ring 2-1 connects the piston assembly, the valve cover and the valve body to form a low-pressure chamber of the pressure reducer. In a structure in FIG. 8, merely key components are drawn, and three butting ports are not drawn. A valve outlet is provided with an upper butting port. A valve inlet is provided with a lower butting port and a side butting port being in communication with the high-pressure chamber.

A top end of the valve cover 3 is provided with a throat 3-1, which is a second depressurization structure of the pressure reducer. A low-pressure chamber is formed between the first depressurization structure 1-2 and the second depressurization structure 3-1. A pressure of the low-pressure chamber is related to the spring force, an induction area of the piston assembly 2 and the second depressurization structure 3-1. A pressure after the second depressurization structure 3-1 is an outlet pressure. A number of noise reduction flow channels are arranged above and below the second depressurization structure 3-1. In FIG. 8, first noise reduction flow channels 3-21 and 3-22 are respectively arranged above and below the second depressurization structure 3-1, and flow channels are gradually reduced to 3-21 and 3-22 at a certain angle, and then gradually expanded at a certain angle. The number of noise reduction flow channels are arranged above and below the second depressurization structure as needed. The noise reduction flow channel and the second depressurization structure may be formed by screwing or welding, which effectively reduces the noise generated by high-speed gas flow. A ratio d3/d2 of a diameter of the noise reduction flow channel below the second depressurization structure to a diameter of the second depressurization structure is 1.1 to 2.4, preferably 1.3 to 1.8. A ratio d4/d2 of a diameter of the noise reduction flow channels above the second depressurization structure to the diameter of the second depressurization structure is 1.5 to 3.2, preferably 1.7 to 2.6. The valve cover 3 is provided with a number of side holes 3-3, so that that an installation space of the spring 4 is connected to the atmosphere. Therefore, a pressure change in a space caused by a movement of the spring may be avoided, the depressurization performance may be affected, and meanwhile, a total weight of the valve may be effectively reduced. The valve body 1 and the valve cover 3 are pressure comparison elements of the pressure reducer, and the first depressurization structure and the second depressurization structure are set to distribute the high-pressure chamber, the low-pressure chamber and the outlet pressure reasonably. A ratio d1/d2 of a diameter of the first depressurization structure and a diameter of the second depressurization structure is 1.1 to 2, preferably 1.4 to 1.7. A pressure of the low-pressure chamber is directly related to the spring force, a dimension of the second depressurization structure and the induction area of the piston assembly. The induction area of the piston assembly is mainly determined by a diameter D1. A ratio D1/D2 ranges from 2 to 2.8, preferably from 2.2 to 2.5.

The valve body 1 and the valve cover 3 are the pressure comparison elements of the pressure reducer, forming two depressurization structures. A ratio d1/d2 of a diameter of the first depressurization structure and a diameter of the second depressurization structure is 1.1 to 2, preferably 1.4 to 1.7. After the high-pressure chamber, the low-pressure chamber and the outlet pressure are distributed reasonably, the pressure reducer outputs needed outlet pressure and hydrogen flow. Dimensions of the depressurization structures d1 and d2 are larger than that of a valve port adopting the first depressurization structure, which reduces the machining difficulty and improves the machining accuracy.

The spring 4 is installed on a step surface 1-3 at the upper end of the valve body, and the upper end is attached to a bottom 2-5 at the large end of the piston assembly. The spring force is balanced with a medium force applied to the induction area of the piston assembly 2, and inlet and outlet directions of the valve are coaxial with a movement direction of the spring, so that a radial dimension of the valve is small and an installation space of the valve is saved.

The working principle of the present disclosure is as follows.

When the high-pressure hydrogen enters the high-pressure chamber of the valve, due to the fact that the piston assembly and the first depressurization structure are in a disengaged state, and the hydrogen passes through the first depressurization structure and the second depressurization structure sequentially and then is output. Since the dimension of the first depressurization structure is larger than that of the second depressurization structure, the pressure of the low-pressure chamber gradually increases with the entry of high-pressure gas, and a downward medium force of the low-pressure chamber is applied to the piston assembly and the piston assembly begins to overcome an upward spring force, so that the piston assembly moves downward until a resultant force tends to be balanced. At this time, the output pressure of the pressure reducer is reached, and the hydrogen with a fixed flow rate is provided to the combustor.

The basic principle, main features and advantages of the present disclosure have been shown and described above. The present disclosure is not limited by the above-mentioned implementations. What has been described in the above-mentioned implementations and specifications is merely the principle of the present disclosure. Various changes and improvements may be made in the present disclosure without departing from the spirit and scope of the present disclosure, and these changes and improvements fall within the scope of the present disclosure. The scope of the present disclosure is defined by the appended claims and their equivalents.

In the present disclosure, the pressure reducing valve depressurizes and stabilizes released high pressure hydrogen, and then supplies hydrogen to the combustor. The switch assembly and a fixing mechanism of the depressurization hydrogen supply device are integrated on the pressure reducing valve via the butting port and a lug of the pressure reducing valve.

In the present disclosure, the cam is provided with double seals, and the axial forces exerted on the cam are counteracted according to a principle of force balance. In addition, the gasket is made of a low friction material. Thus, an opening and closing torque of the cylinder opening valve is effectively reduced, and the opening and closing torque is lower than 4N·m.

In the present disclosure, the opening and closing limit structure (screw) and an arc groove of the cam form an opening and closing mechanical limit mechanism of the device, which limits a rotation angle of the cam, ensures that the opening or closing of the cylinder opening valve is in place, and prevents the valve from automatically closing.

In the present disclosure, the ejector pin is provided with an air guide hole. After being released from the cylinder opening valve, the high-pressure hydrogen enters the pressure reducing valve via the ejector pin and the air guide hole.

In the present disclosure, the gas cylinder cap connects the gas cylinder and the pressure reducing valve into a whole, the ejector pin and the small spring are installed in the gas cylinder cap, and the cylinder opening valve is installed at a gas cylinder opening. Thus, the gas cylinder cap organically connects the cylinder opening valve, the pressure reducing valve and the switch assembly to form the lightweight depressurization hydrogen supply device.

In the present disclosure, the lightweight depressurization hydrogen supply device is configured to connect the gas cylinder to the combustor in a torch combustion system into a whole, is configured to open or close the gas cylinder, and perform the depressurization of the high pressure hydrogen and hydrogen sealing, thus solving problems of depressurization at a large depressurization ratio, high reliable sealing, a low opening and closing torque, and having advantages of wide temperature range, miniaturization and lightweight. The device is suitable for a pressure of 1 MPa G to 70 MPa G, an operating temperature of −40° C. to 60° C., a weight of less than 230 g, an axial dimension of less than 180 mm, and a radial dimension of less than 60 mm.

In the present disclosure, the cylinder opening valve has characteristics of reliable sealing, miniaturization and lightweight, and also has a function of hydrogen filling.

In the present disclosure, a single spring high-pressure pressure reducer is merely composed of four metal pieces, with simple structure and precise and compact parts, thus realizing a lightweight and miniaturized design of the valve. The single spring high-pressure pressure reducer in the present disclosure has reliable performance and there is merely one moving part, so it is not easy to break down and has high reliability.

Parts that are not described in detail in the present disclosure belong to the common knowledge of those skilled in the art.

1. A lightweight depressurization hydrogen supply device suitable for a hydrogen energy handheld torch, configured to connect a gas cylinder to a combustor in the torch, comprising:
a cylinder opening valve;
a pressure reducing valve;
a switch assembly;
a switch actuating component; and
a gas cylinder cap;
wherein the pressure reducing valve is configured to perform depressurization of high pressure hydrogen, and is provided with three butting ports, wherein a lower butting port is connected to the gas cylinder cap, an upper butting port is connected to the combustor, a side butting port is provided with the switch assembly, and the switch actuating component and the cylinder opening valve are installed in the gas cylinder cap; the switch assembly is configured to control the switch actuating component to open or close the cylinder opening valve; the cylinder opening valve is connected to a cylinder opening of the gas cylinder and configured to open or close the gas cylinder.

2. The depressurization hydrogen supply device of claim 1, wherein the switch assembly comprises a cam, a gasket, and a compression nut;
wherein the cam is installed at the side butting port of the pressure reducing valve and is divided into four portions in sequence along an axis of the side butting port, an outermost portion of the cam is connected to the side butting port via the compression nut, and the gasket and the outermost portion are compressed by the compression nut; a second portion of the cam adjacent to the outermost portion is provided with a groove, and an opening and closing limit structure of the cam is installed in the groove to prevent the cylinder opening valve from closing automatically; a third portion of the cam is a cam convex surface, a position of the cam convex surface corresponds to that of the switch actuating component, and the cam convex surface is configured to change an opening and closing manner of the cylinder opening valve from linear motion to rotation; the second portion and a fourth portion of the cam are provided with sealing rings, and axial forces exerted on the cam are counteracted by a double sealing ring structure of the sealing rings, an end face of the outermost portion is provided with a key slot, and a driving force for the rotation of the cam is provided via the key slot.

3. The depressurization hydrogen supply device of claim 2, wherein a position of the opening and closing limit structure is configured to ensure that when the cam is rotated in a first direction, the cam convex surface presses down an ejector pin, and the cylinder opening valve is opened, or when the cam is rotated in a second direction, the cam convex surface is separated from an ejector pin, and the cylinder opening valve is closed; the limit of rotation in the first and second directions is achieved by contacting the opening and closing limit structure with two end faces of the groove.

4. The depressurization hydrogen supply device of claim 3, wherein in a process of opening the cylinder opening valve, after a tip of the cam convex surface rotates to reach a lowest point, the tip of the cam convex surface continues to move until the tip of the cam convex surface forms a slight included angle β with a vertical direction to reach an opening limit position; β is in a range of 3° to 18°, preferably 5° to 10°.

5. The depressurization hydrogen supply device of claim 2, wherein the switch actuating component comprises an ejector pin and a spring;
wherein the ejector pin has a stepped cylindrical structure with an upper surface being a spherical surface and is placed in a central through hole of the gas cylinder cap, the spherical surface is configured to contact with the cam convex surface, and a bottom surface of the ejector pin is in contact with the cylinder opening valve for providing an opening thrust; the spring is compressed and installed in a stepped surface of the ejector pin and a stepped surface of the central through hole.

6. The depressurization hydrogen supply device of claim 1, wherein the pressure reducing valve comprises a valve body, a piston assembly, a valve cover and a spring;
wherein an upper end of the valve body is provided with a cylinder, and an outer bottom of the cylinder is provided with a step; the spring is compressed and installed on the step, a small end of the piston assembly is installed in the cylinder, and a large end is installed in an inner chamber of the valve cover; the valve body is provided with a first depressurization structure being in communication with the cylinder, and a high pressure chamber being in communication with a valve inlet is arranged below the first depressurization structure; the valve cover is provided with a second depressurization structure being in communication with a valve outlet; the piston assembly is provided with a double sealing structure, and the double sealing structure connects the piston assembly, the valve cover and the valve body to form a low pressure chamber of the pressure reducing valve; the second depressurization structure is in communication with the low pressure chamber; the valve outlet is provided with the upper butting port; the valve inlet is provided with the lower butting port and the side butting port being in communication with the high pressure chamber.

7. The depressurization hydrogen supply device of claim 6, wherein the second depressurization structure is a throat with a noise reduction structure, and the noise reduction structure is a plurality of noise reduction flow channels arranged above and below the throat to reduce noise generated by high-speed gas flow; the noise reduction flow channels comprise a throat flow channel with a diameter of d4 above the throat and a throat flow channel with a diameter of d3 below the throat; funnel-shaped flow channels are arranged between the two throat flow channels and the throat with the noise reduction structure; a small end diameter of an upper funnel-shaped flow channel is consistent with a diameter of the throat; a small end diameter of a lower funnel-shaped flow channel is d3.

8. The depressurization hydrogen supply device of claim 7, wherein a ratio d3/d2 of a diameter of the throat flow channel in the noise reduction flow channels to a diameter of the second depressurization structure is 1.1 to 2.4, preferably 1.3 to 1.8; a ratio d4/d2 of a diameter of the throat flow channel in the noise reduction flow channels to the diameter of the second depressurization structure is 1.5 to 3.2, preferably 1.7 to 2.6, and a number of noise reduction flow channels are arranged above and below the second depressurization structure.

9. The depressurization hydrogen supply device of claim 7, wherein a ratio d1/d2 of a diameter of the first depressurization structure and a diameter of the second depressurization structure is 1.1 to 2, preferably 1.4 to 1.7.

10. The depressurization hydrogen supply device of claim 6, wherein the piston assembly consists of four stepped cylindrical surfaces whose diameters increase sequentially from the small end, and an end surface of a cylindrical surface at a smallest end is nested with a non-metallic material for protecting the first depressurization structure; guide holes are provided around side surfaces to a center, converge to the center and communicate with the guide holes on a central axis to an inner hole at the large end; sealing rings are arranged on an outer side of a cylindrical surface at a largest end and an outer side of a cylindrical surface with a second small diameter to realize sealing connection with the inner chamber of the valve cover and a cylinder of the valve body, respectively.

11. The depressurization hydrogen supply device of claim 10, wherein a ratio D1/D2 of a diameter of a cylinder at the largest end to a diameter of a cylinder with the second small diameter is 2 to 2.8, preferably 2.2 to 2.5.

12. The depressurization hydrogen supply device of claim 1, wherein the cylinder opening valve comprises a valve body, a valve core assembly, a spring, a spring chamber and a sealing ring;
wherein the spring chamber is connected to the valve body, the valve core assembly and the spring are arranged in the spring chamber, a valve body sealing lip is arranged on the valve body, and the sealing lip and the valve core assembly are sealed by means of a principle of compressing a non-metallic material to reach a sealing specific pressure of the non-metallic material, and the spring is configured to provide a sealing force for the valve core assembly; the sealing ring is arranged on an outer side of the valve body, so as to ensure sealing between the valve body and the gas cylinder; a through hole is provided in the spring chamber and used as a hydrogen inlet, and a hydrogen intake hole and a central flow channel of a valve core are provided in the valve core assembly; when the cylinder opening valve is opened, a sealing force provided by the spring for the valve core assembly and an upward medium force applied to the valve core assembly in an under-pressure state are overcome, hydrogen enters a central through hole in the valve body through the hydrogen inlet, the spring chamber, the hydrogen intake hole and the central flow channel of the valve core, and flows out via the central through hole, so as to realize hydrogen discharging.

13. The depressurization hydrogen supply device of claim 12, wherein the valve core assembly comprises the valve core and a structural member of a non-metallic material;
wherein the valve core comprises a central valve core, a bottom cylinder and a large-diameter structure between the central valve core and the bottom cylinder for installing the structural member of the non-metallic material; the central valve core is axially provided with the central flow channel of the valve core, and a side wall of the flow channel is provided with the hydrogen intake hole; the bottom cylinder is configured to install one end of the spring, an installation position of the structural member of the non-metallic material corresponds to a position of the valve body sealing lip, and an angle between a direction of a force applied to the structural member of the non-metallic material and a deformation direction of the non-metallic material during sealing is varied to adapt to hydrogen working conditions under different pressures.

14. The depressurization hydrogen supply device of claim 13, wherein the structural member of the non-metallic material is an annular member, and when a cross-sectional shape of the annular member is quadrangular, the structural member is installed in a inlaid manner, and is suitable for hydrogen working conditions not higher than 10 MPa G; or when a cross-sectional shape of the annular member is isosceles trapezoid, the structural member is installed in an injection-molded manner, and is suitable for hydrogen working conditions not higher than 20 MPa G; a direction of a force applied to the valve core assembly is at a wide angle to the deformation direction of the non-metallic material, which is suitable for hydrogen working conditions below 70 MPa G.

15. The depressurization hydrogen supply device of claim 14, wherein the structural member of the non-metallic material is a stepped annular member, and other surfaces except stepped surfaces of the structural member are wrapped and installed by the large-diameter structure on the valve core assembly, the stepped surfaces wrap an outer edge of the valve body sealing lip with a enveloping angle of 90° to ensure sealing in both radial and axial directions, and the valve body sealing lip and the valve core assembly are provided with metal stops to prevent the valve body sealing lip from crushing the structural member of the non-metallic material in an axial position under a high pressure working condition.

16. The depressurization hydrogen supply device of claim 14, wherein a diameter d1 of the valve body sealing lip matched with the valve core assembly in a form of an inlaid non-metallic material ranges from 2 to 10 mm, preferably from 2.5 to 8 mm, a diameter d2 of the valve body sealing lip matched with the valve core assembly in a form of an injection-molded non-metallic material ranges from 2 to 8 mm, preferably from 2.5 to 7 mm, and a diameter d3 of the valve body sealing lip matched with the valve core assembly in a form an extruded sealing ring ranges from 2 to 5 mm, preferably from 2.5 to 4 mm.

17. The depressurization hydrogen supply device of claim 1, wherein the device is suitable for a pressure of 1 MPa G to 70 MPa G, an operating temperature of −40° C. to 60° C., a weight of less than 230 g, an axial dimension of less than 180 mm, and a radial dimension of less than 60 mm.
